(19) United States
(12) Patent Application Publication
(10) Pub. No.: US 2012/0280019 A1
(43) Pub. Date: Nov. 8, 2012

(54) ULTRASONIC WELDING APPARATUS

(75) Inventors: Larry Van Reatherford, Clarkston, MI (US); Jan Skogsmo, Molndal (SE); Daniel Edward Wilkosz, Saline, MI (US); Elizabeth Therese Hetrick, Ann Arbor, MI (US); Ray Jahn, Ann Arbor, MI (US)

(73) Assignees: JAGUAR CARS LIMITED, Coventry (GB); FORD GLOBAL TECHNOLOGIES, LLC, Dearborn, MI (US)

(21) Appl. No.: 13/529,409

(22) Filed: Jun. 21, 2012

Related U.S. Application Data
(62) Division of application No. 11/492,601, filed on Jul. 25, 2006.

(51) Int. Cl. B23K 20/10

(52) U.S. Cl. 228/1.1

(57) ABSTRACT

An ultrasonic welding apparatus and method for detaching or effecting release of an ultrasonic welding tool stuck or attached to a weldment. The method includes the step of utilizing a mechanism mounted adjacent to the ultrasonic welding tool to hold the weldment in position during welding and/or while the ultrasonic welding tool is withdrawn and, if necessary, using the mechanism to detach the weldment from the ultrasonic welding tool. The method contemplates providing a twist, rotary or axial motion to one of the ultrasonic welding tool or weldment to effect release of the ultrasonic welding tool. The apparatus may include a clamp member having a distinct clamping area or pad located adjacent to the sonotrode or anvil of the ultrasonic welding tool. The clamp mechanism provides vibration control, noise mitigation, and a more uniform boundary condition during welding and facilitates part release upon the completion of the welding process.

### FEDERAL SPONSORSHIP

The U.S. Government has a paid-up license in this invention and the right, in limited circumstances, to require the patent owner to license others on reasonable terms as provided for by the terms of Contract No. 70NANB3H3015 awarded by the National Institute of Standards and Technology.

### CROSS-REFERENCE TO RELATED APPLICATIONS

Not Applicable

### BACKGROUND OF THE INVENTION

1. Field of the Invention

The present invention relates generally to an ultrasonic welding apparatus and more specifically to an ultrasonic welding apparatus having weld tooling designed for vibration control and part release.

2. Description of Related Art

Ultrasonic welding of various materials is known. The process involves vibrating overlapping workpieces clamped between a sonotrode and an anvil. Frictional forces occurring between the vibrating workpieces create a bond or weld that occurs at the interface between the workpieces, effectively joining them to one another. Various sonotrode and anvil surface configurations; i.e., the surface that contacts the workpieces, are known and used to transfer energy from the sonotrode to the interface between the workpieces.

Ultrasonic welding of thin metal sections is well known. It is also known that during ultrasonic metal welding, a circular collar clamp may be applied around the weld area in order to prevent workpiece rotation, effect weld quality consistency, and mitigate the energy emanating from the weld area, thereby allowing welding in close proximity to prior welds. Collar clamps, about the anvil and welding tip, however, can restrict access to numerous joint locations, such as sheet metal flanges, whose size is typically minimized in order to reduce component weight and material cost.

Another common issue during ultrasonic welding of metals is sticking/welding of the sonotrode tip and/or anvil to the workpiece. The magnitude of sticking is a function of weldment materials, weld tooling design, and welding parameters employed. When sticking forces are low, removing the tools, both the sonotrode and anvil, from the workpiece or weldment typically does not cause any damage. However, when the sticking force is high, pulling the tool off the weld can damage the weld or deform the workpiece or weldment. The deformation problem worsens with thinner gauge workpieces. Further, even if no workpiece deformation results, stresses induced into the joint or weld when pulling the tool off may have a negative influence on the weld properties. Accordingly, it is desirable to have some mechanism or device for detaching a stuck ultrasonic welding tool.

### SUMMARY OF THE INVENTION

Accordingly, the present invention is an apparatus and method for vibration control during ultrasonic metal welding and part release upon the completion of the welding process. The method includes the steps of utilizing a mechanism mounted adjacent to the sonotrode to hold the weldment in position during welding and potentially while the sonotrode is withdrawn and, if necessary, using the mechanism to detach the weldment from the sonotrode.

In one embodiment, rotating the weldment, the sonotrode and/or the anvil provides a twist, rotary or angular motion relative to the sonotrode axis to effect a release of the ultrasonic welding device from the weldment. The rotation may be about the axis of the sonotrode and in the plane of the weldment or the axis of rotation may be transverse to the weldment and in the same plane as the sonotrode axis. In some instances, it may be a combination of both.

In an additional embodiment, the ultrasonic welding apparatus includes a mechanism located adjacent to or near the sonotrode to hold the weldment when retracting the sonotrode. In an alternative embodiment, mechanisms located on each side of the weldment operate to remove either the anvil and/or the sonotrode from the weldment.

In a further embodiment of the invention, a mechanism located adjacent to or near the sonotrode holds the workpiece or weldment stationary while the sonotrode and/or anvil rotate to detach the workpiece from the sonotrode or anvil.

A further embodiment of the invention includes a clamp mechanism having a clamping area or pad located adjacent to the sonotrode or anvil. The clamp mechanism provides vibration control, noise mitigation, and a more uniform boundary condition during welding and facilitates part release upon the completion of the welding process. Clamp material can be selected to achieve optimal damping, surface marking, durability, and welding characteristics.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an ultrasonic welding apparatus according to one embodiment of the present invention.

FIGS. 2A-2C are schematic views of various embodiments of a device for use in detaching a sonotrode and/or anvil according to the present invention.

FIG. 3 is an alternative embodiment of an ultrasonic welding apparatus according to the present invention.

FIG. 4 is a schematic view of an alternative embodiment of an ultrasonic welding apparatus according to the present invention.

FIG. 5 is a perspective view of the respective upper and lower portions of the ultrasonic welding apparatus illustrated in FIG. 4.

FIG. 6 is a schematic view of a further embodiment of a sonotrode for use with an ultrasonic welding apparatus according to the present invention.

FIG. 7 is a schematic view of another embodiment of an ultrasonic welding apparatus according to the present invention.

FIG. 8 is a top view of the ultrasonic welding apparatus illustrated in FIG. 7.

### DETAILED DESCRIPTION OF THE PREFERRED EMBODIMENTS

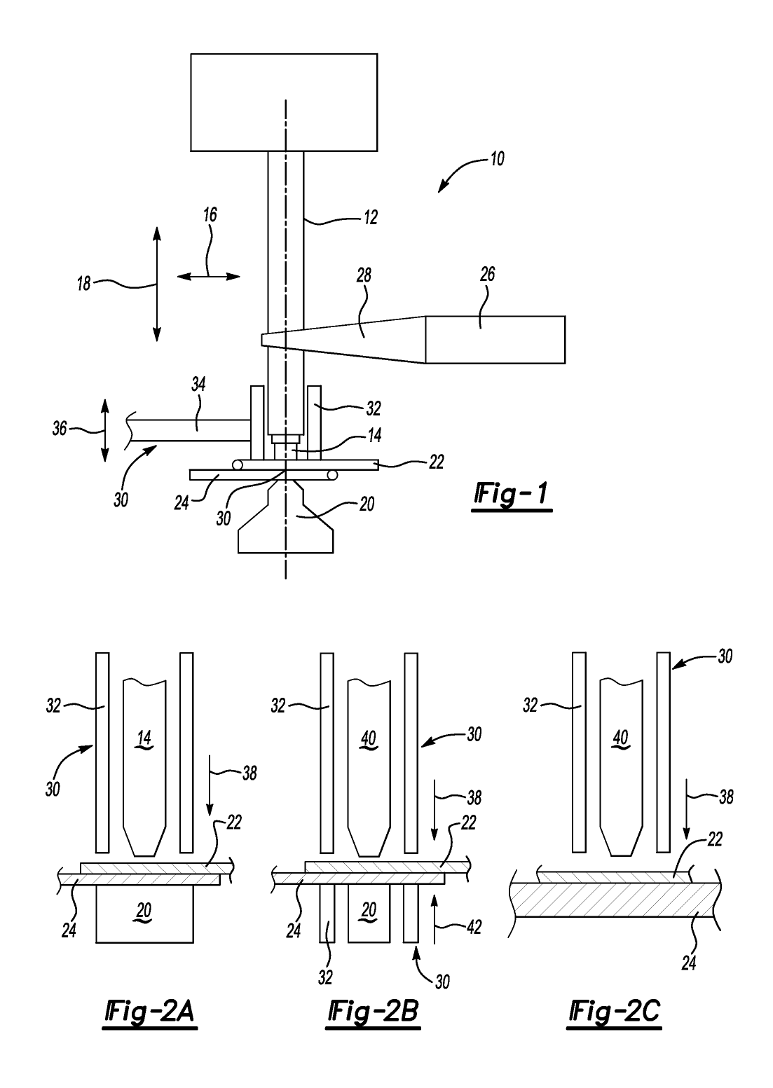

FIG. 1 shows an ultrasonic welding apparatus, seen generally at 10, according to one embodiment of the present invention. The ultrasonic welding apparatus 10 includes a reed 12 having a sonotrode 14 mounted at one end thereof. The reed 12 is mounted for movement in a side-to-side or horizontal direction of vibration, shown by the arrow 16. The reed 12 also moves in a vertical manner, shown by the arrow 18, and in cooperation with an anvil 20 holds first 22 and second 24 workpieces in position under moderate clamping forces. Once the workpieces 22, 24 are held in position, a transducer 26, connected to the reed 12 by a wedge 28, vibrates the reed 12 at a high frequency (typically 15 to 40 kHz) to impart energy through the sonotrode 14 to the first 22 and second 24 workpieces at a location between the sonotrode 14 and the anvil 20 to create a bond or weld at the interface or adjacent surfaces 31 of the workpieces 22, 24 thereby creating a weldment. As used herein, the term sonotrode generally refers to a tool attached to the reed of an ultrasonic welding apparatus and it may be referred to as the sonotrode tip. Accordingly, the sonotrode or sonotrode tip refers to a gripping tool attached to the end of the reed.

FIG. 1 also illustrates a clamp mechanism or engagement member, seen generally at 30, including a clamp member 32 and a support member 34. The clamp mechanism 30 is mounted for movement in a vertical manner as indicated by the arrow 36. The clamp mechanism 30 is mounted such that it moves or travels independently of the ultrasonic welding apparatus 10. Accordingly, the clamp mechanism 30 provides a clamping force to secure and hold the first 22 and second 24 workpieces in position. It should be understood that this clamp force may be in addition to a separate force provided by the reed 12 and anvil 20. As set forth more fully herein, the clamp mechanism 30 also assists in removing a weldment from the ultrasonic welding apparatus 10 if the weldment becomes stuck to the ultrasonic welding apparatus 10. In addition, it also operates as an isolator to isolate other areas of the weldment from the ultrasonic vibrations occurring during the welding process.

Various embodiments of a clamping mechanism 30 for use with an ultrasonic welding apparatus 10 are schematically illustrated in FIGS. 2A-2C. FIG. 2A illustrates the clamping mechanism 30 moving downward in the direction of the arrow 38 to engage the first workpiece 22. The anvil 20 has a size such that the clamping mechanism 30 holds the first 22 and second 24 workpieces in position against the anvil 20. The sonotrode 14, moving independently of the clamping mechanism 30, engages the first workpiece 22 and performs the welding operation. Accordingly, FIG. 2A illustrates the use of a single clamping mechanism 30 operating on one side of the weldment only.

In the preferred embodiment, the clamp 32 of the clamp mechanism 30 is located as close as possible to the sonotrode 14. Once the weld is completed, the sonotrode 14 is retracted with the clamp 32 still engaging the weldment. Thus, the clamp 32 stabilizes the weldment and minimizes the likelihood of deformation. In some instances, the clamp 32 applies additional force to push the weldment off the sonotrode 14. As set forth more fully herein, the clamp mechanism 30 also functions as a weld isolation device.

Turning to FIG. 2B there is illustrated an ultrasonic welding tool utilizing upper and lower clamping mechanisms 30. Again, the sonotrode 14 moves independently of the upper and lower clamping mechanisms 30, with the clamping mechanisms 30 moving independent of one another; i.e., the upper clamping mechanism 30 moves downward as illustrated by the arrow 38 and the lower clamping mechanism 30 moves upward as illustrated by the arrow 42. The upper and lower clamping mechanisms 30 oppose one another and may or may not engage the first and second workpieces 22, 24 during the ultrasonic welding operation. As required, the upper and lower clamping mechanisms 30 engage the weldment; i.e., the unit formed by welding the first and second 22, 24 workpieces together, to hold the weldment stationary while the respective anvil 20 and sonotrode 14 are removed or withdrawn. Accordingly, the upper and lower clamping mechanisms 30 function to hold the weldment stationary while the sonotrode tip 14 or anvil 20 are rotated, twisted or otherwise moved to release a stuck sonotrode 14 or anvil 20. The clamping mechanism 30 also pushes the weldment off the anvil 20 or sonotrode 14 should the weldment become stuck to either the sonotrode 14 or the anvil 20. In addition, the clamping mechanism 30 acts to isolate vibration during the welding process.

FIG. 2C illustrates a further embodiment wherein the second workpiece 24 is of a size and mass where it functions as an anvil. The clamping mechanism 30 helps with removal of the sonotrode 14 should the sonotrode 14 become stuck to the first workpiece 22 during the welding operation. Again, the upper clamping mechanism 30 either pushes the weldment off the sonotrode 14 or holds the weldment stationary while the sonotrode 14 is withdrawn or released from the first workpiece 22. In addition to the axial motion set forth above, a rotating, twisting or other type of angular motion can also be used to withdraw or release the sonotrode 14 from the first workpiece 22.

Turning now to FIG. 3, shown is an alternative embodiment illustrating a clamping mechanism, seen generally at 50, including a clamp member 52 mounted for reciprocal motion in the direction shown by the arrow 54. Power cylinders 56 or other drive members are used to move the clamp member 52. As illustrated, the anvil 20 is rotatably mounted in a support 66 located on the frame member 68. Upon receiving a signal from a controller 62 a rotatable shaft 60 connected to the anvil operates to rotate the anvil 20 in the direction shown by the arrow 64. The clamping mechanism 50 holds the weldment stationary whereby rotation of the anvil 20 in the direction of the arrow 64 releases the stuck anvil 20. In addition, the clamping mechanism 50 may also function to apply an axial force to the second workpiece 24 to separate the anvil 20 from the second workpiece 24. As such, part release from the anvil 20 can be effected independently of release from the tip.

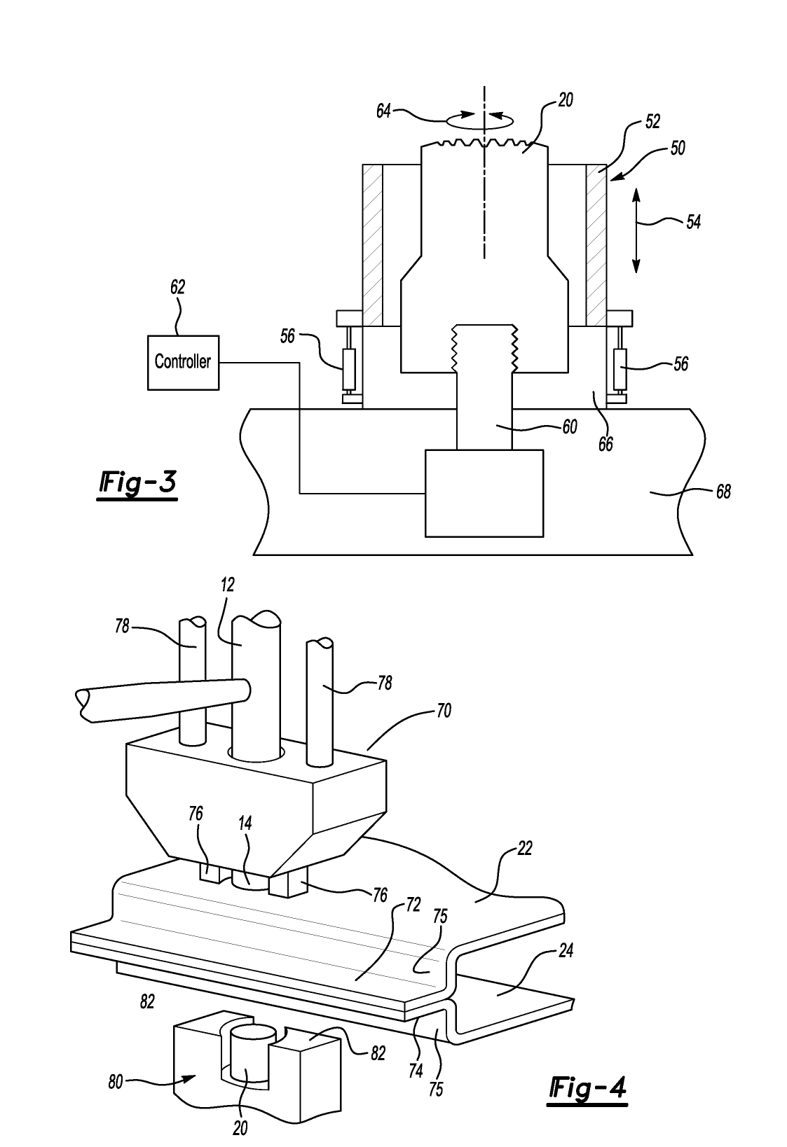

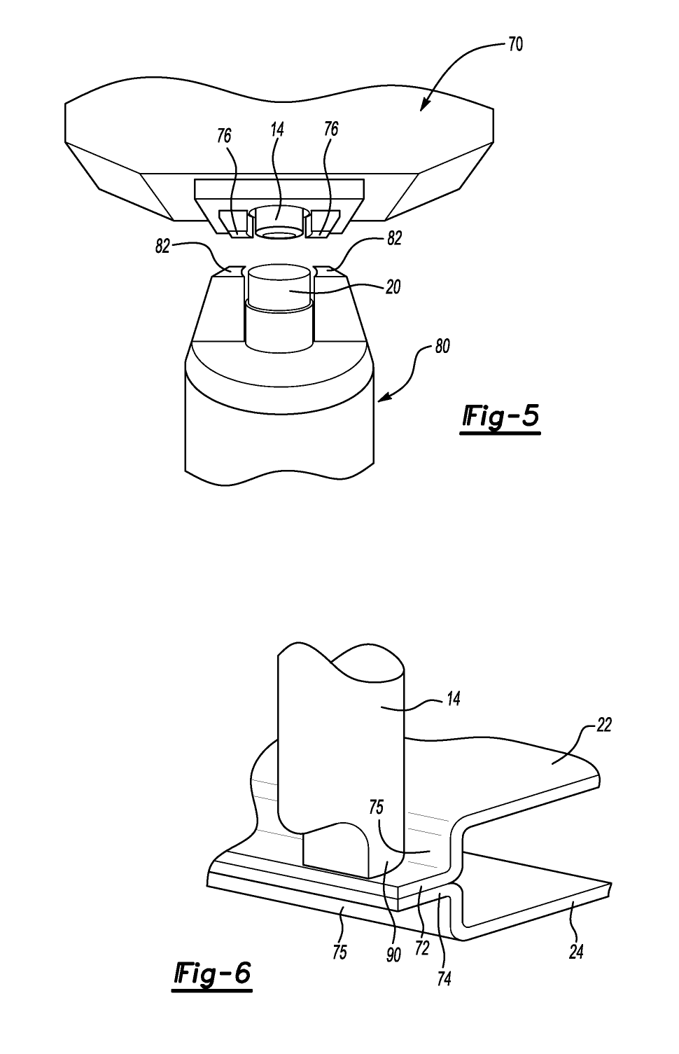

Turning now to FIGS. 4-5 there is shown a further embodiment of the present invention illustrating an isolation and welding clamp, seen generally at 70, used in conjunction with an ultrasonic welding device, including a sonotrode 14, to weld sheet metal flanges 72, 74 of the first 22 and second 24 workpieces, respectively. As illustrated, the first and second 22, 24 workpieces are located or inserted into the opening or space forming the work area located between the anvil 20 and sonotrode 14. The clamp 70 includes distinct clamping areas or pads 76 located close to the sonotrode 14. As with the previous embodiments, the sonotrode 14 and reed 12 move independently of the clamp 70. Support bars 78 attached to the clamp 70 operate to raise and lower the clamp 70 into engagement with the workpiece 22.

A similar lower clamp design, seen generally at 80, includes clamp pads 82 located close to the anvil 20. The lower clamp 80 also moves independent of the anvil 20. The clamp pads 82 on the lower clamp member 80 are located opposite the clamp pads 76 located on the upper clamp 70. Together with the clamp pads 76 on the upper clamp 70 the lower clamp pads 82 operate to secure the flanges 72, 74, isolate the effect of vibrations occurring during the ultrasonic welding operation on adjacent welds or structures and facilitate, if necessary, the removal of a stuck sonotrode or anvil.

As illustrated, the clamp geometry, specifically the location and placement of the clamp pads 76, 82 is such that the clamp and correspondingly the clamp surface is not completely concentric about and does not surround the sonotrode 14 or the anvil 20. Instead, the upper and lower clamps 70, 80 are designed to engage a flange portion 72, 74 of the respective workpieces 22, 24. As illustrated, the rectangular shape of the clamp pads 76, 82 enables placement of the clamps 70, 80 close to the inboard edge or surface 75 of the respective flanges 72, 74. While shown as two rectangular shaped clamp pads 76 located on opposite sides of the sonotrode tip 14, the shape or configuration and position or location of the clamp pads 76, 82 are all variable. For example, angle or corner welds may require that the clamp pads be placed at angles relative to one another. Further, the configuration of the clamp pads 76, 82 may change to change the isolation and vibration control aspects of the clamp 70 in order to reduce or mitigate vibration in certain areas or locations of the workpiece during the welding operation. In this manner, welds can be placed adjacent or close to one another without a subsequent welding process disturbing previous welds. Accordingly, depending upon the particular welding process the use of separate and distinct clamps or clamp pads provides an easily modified and changed multifunctional ultrasonic welding tool.

In addition, the clamp pads 76, 82 can be made of various materials to mitigate and dampen vibration and thereby isolate the flange area beyond the clamp pads 76, 82 from the effect of vibrations in the weld region. For example, the clamp pads 76, 82 can be made of various materials including plastics, polymers and copolymers such as polytetrafluoroethylene, ceramics, steels, and other metals. The particular clamp pad 76, 82 material chosen for use may depend on material wear life; vibration, noise isolation and absorption qualities; and material and manufacturing costs. In addition, the clamps 70, 80 and the material forming the clamp pads 76, 82 also function and cooperate with the particular clamp configuration to mitigate component or part vibration and reduce noise occurring during the welding process.

Accordingly, the clamp 70, 80 or clamp pad 76, 82 shapes or surfaces can undertake or be formed of different geometries and be formed of different materials. In addition, the clamps 70, 80 or clamp pads 76, 82 may have a contact or pad surface 83 that utilizes different patterns or textures to enhance gripping of the first and second workpieces 22, 24 and ultimately the weldment formed once the individual workpieces are welded together. For example, as shown in FIG. 4, the contact or pad surface 83 of the clamp pad 82 is knurled. It may also have a diamond shape or include a particular design. Thus, the pad surface 83 patterns and textures, including pad surface 83 shapes or designs can vary as necessary to improve part gripping, impart a mark on the weldment, or add a functional characteristic, such as a recess, to the workpiece in the area of the weld.

In addition, while the clamp pads 76, 82 are shown inline or collinear in the disclosed embodiment, it is not necessary for the clamp locations to be aligned in such a manner. The position of the clamp pads 76, 82 depends, in part, upon the workpieces being welded. For instance, the clamp pads are placed at various positions, such as 90° angles, when the ultrasonic welding tool is used to weld in corners, and more than two clamp pads could be used to isolate vibrations and facilitate part release when welding complicated geometries such as a T-junction. In addition, a single clamp pad on only one side of the tip may be used to facilitate improved access when welding in restrictive locations. Further, the clamp pads 76, 82 may be positioned such that they are located off or distanced from a sonotrode center line, such as when used with an offset sonotrode contact surface which can facilitate equipment application on reduced size flanges, as shown in FIG. 6.

In the alternative embodiment illustrated in FIG. 6, the sonotrode 14 has a contact surface 88 that is positioned on one side of the sonotrode 14. Forming the contact surface 88 of the sonotrode 14 in this manner increases the amount of surface area of the contact surface 88 placed on the flange 72, which correspondingly, transfers a greater amount of ultrasonic vibration to the respective first 22 and second 24 workpieces. In this embodiment, the width of the contact surface 88 depends on the width of the flange portion 72, 74. The upper clamp pads 76, and when used lower clamp pads 82, may also either be offset or have a reduced size or profile whereby they fully contact and engage the respective flange portions 72, 74.

As with the previous embodiments, if the second workpiece 24 is an adequately heavy or thick substructure, the second workpiece 24 can function as an anvil and only the upper clamp 70 and sonotrode 14 are used. Such one-sided clamping reduces the need to place an anvil on the backside of the structure. In addition, the upper and lower clamp members 70, 80 may also include a cooling assembly, such as cooling passageways located in the clamp members 70, 80. A cooling fluid circulated through the passageways cools the clamp members 70, 80 and clamp pads 76, 82 and correspondingly reduces or dissipates heat occurring during the ultrasonic welding process.

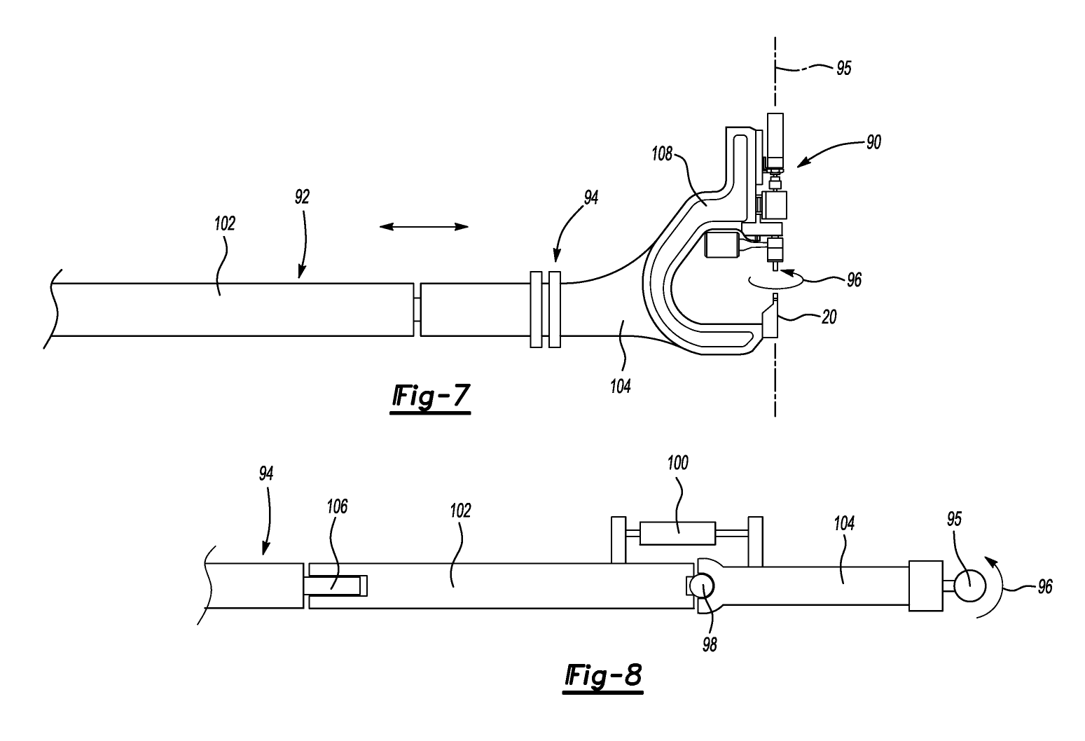

Turning now to FIGS. 7-8 there is shown a further embodiment of an ultrasonic welding apparatus including a release mechanism for releasing a weldment stuck or attached to a sonotrode tip or anvil. As illustrated in the disclosed embodiment, the ultrasonic welding apparatus, seen generally at 90, is mounted on the head portion 108 of a robot arm, seen generally at 92, that moves the ultrasonic welding apparatus 90 into position to perform an ultrasonic welding operation. The present embodiment discloses an apparatus for releasing or freeing a weldment from the ultrasonic welding apparatus 90 if it sticks to the ultrasonic welding apparatus 90 upon conclusion of the welding operation. As shown, the robot arm 92 includes a wrist joint, seen generally at 94, that operates to rotate the ultrasonic welding apparatus 90 slightly about its longitudinal axis 95, as shown by the arrow 96, to effect a release of the ultrasonic welding apparatus 90. Typically, only a slight rotation is required. For example, 1-5° of rotation is sufficient to disengage the ultrasonic welding apparatus 90 from the weldment.

As illustrated in FIGS. 7-8 the wrist joint 94 includes a wrist pin 98 and a dampening/power cylinder 100 pivotally attached, via pivot pins 112 and struts 110 to respective arm portions 102, 104 on opposite sides of the wrist pin 98. A slide joint 106 located in the robot arm 92 operates to allow the arm portions 102, 104 to move slightly when the wrist action or movement of the wrist joint 94 imparts rotation to the ultrasonic welding apparatus 90 about its longitudinal axis 95. This is one method of imparting rotation to the ultrasonic welding apparatus 90; other mechanisms such as rotatably mounting the ultrasonic welding apparatus 90 on the head portion 108 of the robot arm 92 are also suitable. In addition, while the embodiment illustrated in FIGS. 7-8 illustrates a stationary anvil 20, a rotatable anvil 20 of the type or design illustrated in FIG. 3 may also be mounted on the head portion 108 of the robot arm 92.

In a further embodiment, the fixture used to hold the workpiece or weldment may be configured such that part clamping can be implemented at remote locations to mitigate component or part vibration during the ultrasonic welding process. The fixture may also be rotated, typically about the longitudinal axis 95 of the ultrasonic welding apparatus 90 to release the ultrasonic welding apparatus 90 from the weldment. Accordingly, the invention contemplates rotating either the ultrasonic welding apparatus, including either the sonotrode or the anvil, or the weldment to effect release of a stuck ultrasonic welding tool.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An ultrasonic welding apparatus comprising:
a frame;
an ultrasonic welding device attached to said frame, said ultrasonic welding device including a sonotrode;
a drive mechanism attached to said frame and said sonotrode for moving said sonotrode into engagement with a workpiece to perform an ultrasonic welding operation;
a clamp member, said clamp member mounted to said frame for movement independent of said sonotrode, said clamp member operative to engage said workpiece; and
clamp member having a clamp surface for contacting said workpiece, said clamp surface extending only partially about said sonotrode.

2. An ultrasonic welding apparatus as set forth in claim 1 wherein said clamp surface includes a pair of polygonal shaped surfaces extending on opposite sides of said sonotrode.

3. An ultrasonic welding apparatus as set forth in claim 1 wherein said clamp surface is formed of a material different from that of said clamp body.

4. An ultrasonic welding apparatus as set forth in claim 1 wherein said clamp surface includes opposed clamp pads spaced from said sonotrode to isolate the workpiece during the ultrasonic welding process.

5. An ultrasonic welding apparatus as set forth in claim 1 wherein said clamp member includes a cooling assembly.

6. An ultrasonic welding apparatus as set forth in claim 1 wherein said sonotrode includes a contact surface, said contact surface having a centerline, said centerline offset from a centerline of said sonotrode.

7. An ultrasonic welding apparatus as set forth in claim 5 wherein said clamp surface is positioned offset from said centerline of said sonotrode.

8. An ultrasonic welding apparatus comprising:
a frame;
an ultrasonic welding device attached to said frame, said ultrasonic welding device including a sonotrode;
a drive mechanism attached to said frame and said sonotrode for moving said sonotrode into engagement with a workpiece to perform an ultrasonic welding operation;
a clamp member, said clamp member mounted to said frame for movement independent of said sonotrode, said clamp member including a clamp pad operative to engage the workpiece.

9. An ultrasonic welding apparatus as set forth in claim 8 wherein said clamp pad and said clamp member are formed of different materials.

10. An ultrasonic welding apparatus as set forth in claim 8 wherein said clamp pad is formed of a plastic material.

11. An ultrasonic welding apparatus as set forth in claim 8 wherein said clamp pad is formed of a metal material.

12. An ultrasonic welding apparatus as set forth in claim 8 wherein said clamp member is operative on one side of the weldment only.

13. An ultrasonic welding apparatus as set forth in claim 8 wherein actuation of the upper and lower clamp members is independent of one another.

14. An ultrasonic welding apparatus as set forth in claim 8 including a plurality of spaced apart clamp pads operative to engage the workpiece

15. An ultrasonic welding apparatus as set forth in claim 14 wherein said clamp pads are linearly offset from one another on opposing sides of said sonotrode.

16. An ultrasonic welding apparatus as set forth in claim 14 wherein said clamp pads are radially spaced from said sonotrode and angularly offset from one another.

17. An ultrasonic welding apparatus as set forth in claim 8 wherein said clamp pads have a textured pad surface.

18. An ultrasonic welding apparatus as set forth in claim 8 wherein said clamp pads have a predetermined pad surface configuration used to imprint the workpiece.

19. An ultrasonic welding apparatus as set forth in claim 17 wherein said textured pad surface includes a knurled pattern.

20. An ultrasonic welding apparatus as set forth in claim 14 wherein said clamp pads are formed of a plastic material.
